(19) United States
(12) Patent Application Publication
(10) Pub. No.: US 2012/0092260 A1
(43) Pub. Date: Apr. 19, 2012

(54) SERIES-PARALLEL COMBINATION CIRCUIT OF ILLUMINATED KEYBOARD

(75) Inventor: YUNG-LUNG LIU, Ta Ya Shiang (TW)

(73) Assignee: Sunrex Technology Corp., Ta Ya Shiang (TW)

(21) Appl. No.: 12/907,011

(22) Filed: Oct. 18, 2010

(51) Int. Cl. G06F 3/02

(52) U.S. Cl. 345/168

(57) ABSTRACT

A series-parallel combination circuit of an illuminated keyboard including a plurality of key zones, the series-parallel combination circuit comprising a plurality of circuit blocks arranged electrically in parallel, each circuit block comprising at least one resistor and at least one LED arranged electrically in series and corresponding to one of the key zones for illumination thereto. The series-parallel combination circuit can render an uniform illumination on the illuminated keyboard.

### BACKGROUND OF THE INVENTION

1. Field of Invention

The invention relates to illuminated keyboards and more particularly to a series-parallel combination circuit of an illuminated keyboard with improved characteristics.

2. Description of Related Art

Light-emitting diodes (LEDs) are renowned for lower energy consumption, longer lifetime, improved robustness, smaller size, faster switching, and greater durability and reliability. In earlier times, LEDs are used as indicator lamps in many devices, and are now increasingly used for lighting including flashlights and desk lamps, and backlighting module of a liquid crystal display (LCD).

For lighting, stable and uniform illumination is the most important factor in choosing a light source. For LCD, it is required to have a wide screen area with uniform illumination. Backlighting module of an LCD has complicated components including LEDs, light guide boards, illumination enhancing plates, diffusion films, and lens so that a uniform illuminated screen is effected by the activate LEDs.

But a uniform illumination is not critical for some devices having backlighting module. With the above mentioned advantages of LEDs, they still employ a plurality of LEDs as light source of backlighting module for illuminating a flat screen thereof. Typically, direct current (DC) is supplied to a printed circuit board (PCD) from one side. This, however, can cause uneven distribution of illumination on the screen which is illuminated by LEDs of the backlighting module.

Typically, a plurality of LEDs are connected in a plurality of series circuits. This requires a large DC source. Current flows through all LEDs along the series circuit are the same. However, voltage drop is a predetermined volt across each LED and that may not be sufficient to make all LEDs emit uniform light. This means the more distal the LEDs from the DC source the dimmer of the LEDs. As a result, no uniform illumination on the screen is rendered even a plurality of LEDs are mounted on the PCB.

Moreover, each LED is disposed in a one-to-one relationship to a key of the keyboard. Thus a user may be confused in keyboarding. Further, wire disconnection may occur in the PCB due to hole punching of the board in the manufacturing processes. This can significantly decrease yield. Thus, the need for improvement still exists.

### SUMMARY OF THE INVENTION

It is therefore one object of the invention to provide a series-parallel combination circuit of an illuminated keyboard for enabling a user to visually identify a corresponding one of a plurality of key zones of the illuminated keyboard.

It is another object of the invention to provide a series-parallel combination circuit of an illuminated keyboard capable of increasing or decreasing the number of the resistors and resistance thereof so that same current may flow to all circuit blocks of the series-parallel combination circuit to cause the circuit blocks to make an uniform illumination to the illuminated keyboard.

It is a further object of the invention to provide a series-parallel combination circuit of an illuminated keyboard wherein any two adjacent components such as one resistor and one LED, or two LEDs are electrically connected together by at least one wire so as to prevent the series-parallel combination circuit from being damaged due to only one wire disconnection by the hole punching of the board in the manufacturing processes and increasing yield.

To achieve the above and other objects, the invention provides a series-parallel combination circuit of an illuminated keyboard including a plurality of key zones, the series-parallel combination circuit comprising a plurality of circuit blocks arranged electrically in parallel, each circuit block comprising at least one resistor and at least one LED arranged electrically in series and corresponding to one of the key zones for illumination thereto.

In one aspect of the invention, further comprises a light-sensitive switch electrically connected to each of the circuit blocks.

In another aspect of the invention, the at least one LED comprises a plurality of LEDs arranged electrically in series, any two adjacent LEDs are electrically connected together by at least one wire, the at least one resistor comprises a plurality of resistors arranged electrically in series, and at least one resistor and at least one LED are electrically connected together by at least one wire.

In a further aspect of the invention, resistance of the at least one resistor of one circuit block is different from that of the at least one resistor of the remaining circuit blocks, and color of the at least one LED of one circuit block is different from that of the at least one LED of the remaining circuit blocks.

The above and other objects, features and advantages of the invention will become apparent from the following detailed description taken with the accompanying drawings.

### BRIEF DESCRIPTION OF THE DRAWINGS

FIG. 1 is a schematic top plan view of an illuminated keyboard according to the invention; and

FIG. 2 is a circuit diagram of a series-parallel combination circuit of the illuminated keyboard.

### DETAILED DESCRIPTION OF THE INVENTION

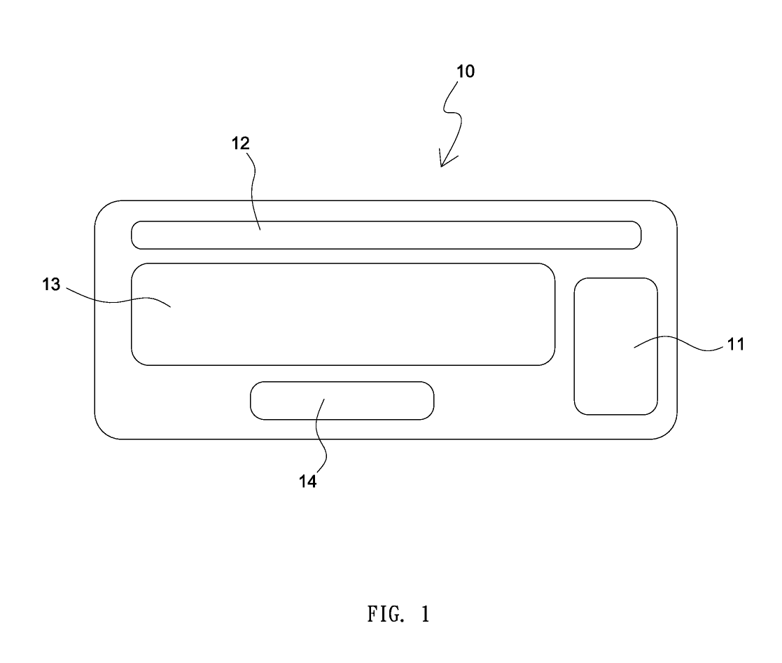

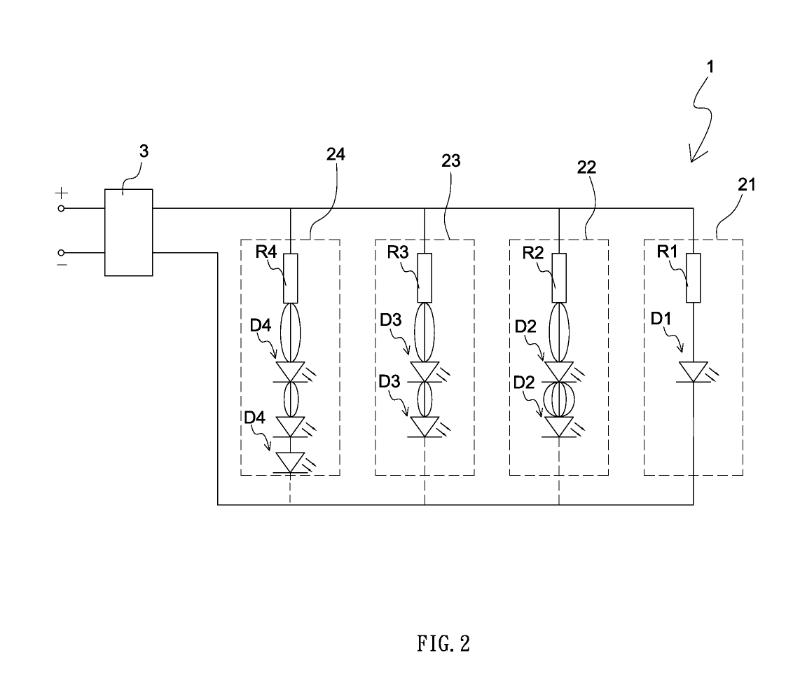

Referring to FIGS. 1 and 2, an illuminated keyboard 10 in accordance with the invention comprises a plurality of key zones including a keypad 11 to the right, a set of command keys 12 to the top, a large keys block 13, and a space bar 14 on the bottom 14. Above layout of the illuminated keyboard 10 is only an exemplary example but not limiting to. Other similar input devices such as membrane keyboards and touch pads are also within the scope of the invention.

A series-parallel combination circuit 1 of the illuminated keyboard 10 comprises a plurality of circuit blocks arranged electrically in parallel. Each circuit block corresponds to one of the keypad 11, the set of command keys 12, the large keys block 13, and the space bar 14 of the illuminated keyboard 10 and is electrically connected thereto. The circuit blocks are comprised of a first circuit block 21, a second circuit block 22, a third circuit block 23, and a fourth circuit block 24.

Each circuit block comprises at least one resistor and at least one LED arranged electrically in series. Specifically, the first circuit block 21 comprises a resistor R1 and an LED D1 arranged electrically in series, the second circuit block 22 comprises a resistor R2 and two LEDs D2 arranged electrically in series, the third circuit block 23 comprises a resistor R3 and two LEDs D3 arranged electrically in series, and the fourth circuit block 24 comprises a resistor R4 and two LEDs D4 arranged electrically in series respectively.

The number of the resistors and the number of the LEDs can be increased or decreased depending on applications. Moreover, any two adjacent components (e.g., one resistor and one LED, or two LEDs) are electrically connected together by at least one wire. This has the benefit of preventing the series-parallel combination circuit from being damaged due to only one wire disconnection by the hole punching of the board in the manufacturing processes (i.e., for example, one wire disconnection will not damage the series-parallel combination circuit). This also makes the invention more durable.

It is understood that in a typical series circuit voltage drop is a predetermined volt across each component (e.g., LED) and that may not be sufficient to make all LEDs emit uniform light. This means the more distal the LEDs from the DC source the dimmer of the LEDs. Advantageously, the invention employs a technique of (a) increasing or decreasing the number of resistors of each circuit block 21, 22, 23, or 24, or (b) having resistors of different resistances in order to make substantially the same current flowing through all circuit blocks. Moreover, each resistor R1, R2, R3, or R4 is formed by printing resistive ink or a plurality of resistors electrically connected in series. Further, wiring of the circuit blocks 21, 22, 23 and 24 of the keyboard 10 is formed by printing conductive ink.

In addition, the LEDs D1, D2, D3 and D4 can have different colors (e.g., red, blue, green, white, etc.) so that a user may visually identify the corresponding one of the keypad 11, the set of command keys 12, the large keys block 13, and the space bar 14 of the illuminated keyboard 10.

The series-parallel combination circuit 1 of the invention further comprises a light-sensitive switch 3 for ease of operation. The light-sensitive switch 3 is electrically connected to each of the circuit blocks 21, 22, 23 and 24. Preferably, the light-sensitive switch 3 can be activated when the environment is sufficiently dark so as to save energy.

The invention has the following advantages and characteristics. The circuit blocks 21, 22, 23 and 24 are arranged electrically in parallel. The resistor R1 is in series with the LED D1, the resistor R2 is in series with the LEDs D2, the resistor R3 is in series with the LEDs D3, and the resistor R4 is in series with the LEDs D4 respectively. Any two adjacent components (e.g., one resistor and one LED, or two LEDs) are electrically connected together by at least one wire so as to prevent the series-parallel combination circuit from being damaged due to only one wire disconnection by the hole punching of the board in the manufacturing processes (i.e., for example, one wire breakage will not damage the series-parallel combination circuit). This also increases the yield. The LEDs D1, D2, D3 and D4 (i.e., circuit blocks 21, 22, 23, and 24) have different colors so that a user may visually identify the corresponding one of the keypad 11, the set of command keys 12, the large keys block 13, and the space bar 14 of the illuminated keyboard 10. It employs a technique of increasing or decreasing the number of resistors of each circuit block 21, 22, 23, or 24 in order to make substantially the same current flowing through all circuit blocks. This can render a uniform illumination to the illuminated keyboard 10.

While the invention has been described in terms of preferred embodiments, those skilled in the art will recognize that the invention can be practiced with modifications within the spirit and scope of the appended claims.

What is claimed is:

1. A series-parallel combination circuit of an illuminated keyboard including a plurality of key zones, the series-parallel combination circuit comprising:
a plurality of circuit blocks arranged electrically in parallel, each circuit block comprising at least one resistor and at least one LED arranged electrically in series and corresponding to one of the key zones for illumination thereto.

2. The series-parallel combination circuit of claim 1, further comprising a light-sensitive switch electrically connected to each of the circuit blocks.

3. The series-parallel combination circuit of claim 1, wherein the at least one LED comprises a plurality of LEDs arranged electrically in series.

4. The series-parallel combination circuit of claim 3, wherein any two adjacent LEDs are electrically connected together by at least one wire.

5. The series-parallel combination circuit of claim 1, wherein each of the at least one resistor is formed by printing resistive ink or a plurality of resistors electrically connected in series, and wherein wiring of the circuit blocks is formed by printing conductive ink.

6. The series-parallel combination circuit of claim 1, wherein the at least one resistor comprises a plurality of resistors arranged electrically in series.

7. The series-parallel combination circuit of claim 6, wherein the at least one resistor and the at least one LED are electrically connected together by at least one wire.

8. The series-parallel combination circuit of claim 1, wherein resistance of the at least one resistor of one circuit block is different from that of the at least one resistor of the remaining circuit blocks.

9. The series-parallel combination circuit of claim 1, wherein color of the at least one LED of one circuit block is different from that of the at least one LED of the remaining circuit blocks.

10. The series-parallel combination circuit of claim 1, wherein the key zones comprise a keypad, a set of command keys, a keys block, and a space bar.
